(19) United States
(12) Patent Application Publication
(10) Pub. No.: US 2007/0050344 A1
(43) Pub. Date: Mar. 1, 2007

(54) Method and apparatus for presenting computerized search results in a medical information system

(75) Inventors: David Michael Rind, Waltham, MA (US); Kevin Collamore Braun, Orange, MA (US); Jason John Haruska, Boston, MA (US)

Correspondence Address: WOLF GREENFIELD & SACKS, PC, FEDERAL RESERVE PLAZA, 600 ATLANTIC AVENUE, BOSTON, MA, 02210-2206, US

(73) Assignee: UpToDate Inc., Waltham, MA (US)

(21) Appl. No.: 11/512,924

(22) Filed: Aug. 30, 2006

Related U.S. Application Data
(60) Provisional application No. 60/712,333, filed on Aug. 30, 2005.
(60) Provisional application No. 60/720,730, filed on Sep. 27, 2005.

(51) Int. Cl. G06F 17/30

(52) U.S. Cl. 707/3

(57) ABSTRACT

A method and system for providing computer search results in connection with a medical information resource that has a plurality of stored medical topic documents. A user may provide a search request and in response have one or more medical topic documents in the medical information resource identified in a search result. A graphical user interface may be presented to the user including a topic title or other indication for the medical topic documents identified in the search result. The graphical user interface may be adapted to display additional information for a document presented in the first graphical user interface based on the user's selection of the title or other indication for the document such that the additional information is incorporated into and displayed simultaneously with at least a portion of the original graphical user interface. For example, a user may position a mouse cursor over a document title, and additional information, such as an outline for the associated document, may be presented.

This application claims the benefit of U.S. Provisional applications 60/712,333, filed Aug. 30, 2005, and 60/720,730, filed Sep. 27, 2005.

### BACKGROUND OF INVENTION

When users perform a computerized search for information, there are many things that can keep them from finding useful information. Spelling mistakes, incorrect use of Boolean terms, vocabulary mismatches, and other issues can render the results of a search useless. Even if a user is extremely meticulous and knowledgeable, it is still not certain that the user will find available and relevant information.

For a computerized search, typically the relevant corpus has already been indexed based on the words found in each document within the corpus. When a user inputs a term or set of terms into a search engine's interface, the search engine looks for the search term(s) in the appropriate index(es) and, usually using some proprietary algorithm, determines which documents in the corpus appear to be relevant to the user's query. The search engine then presents to the user a list of the relevant results, typically hyperlinked to the appropriate documents in the corpus. For example, a search on a corpus containing information about books might return a list of titles, hyperlinked to the corpus entries for those titles.

Once the list of results is presented, it is up to the user to choose the document that contains relevant information she is seeking. Presuming that effective search terms were entered and that the corpus does indeed contain the sought-after information, finding the information should be a simple matter of choosing a result from the list of relevant results and following the related hyperlink.

In practice, however, it may be unclear which item in a list contains information relevant to the user's intended search. Thus, designers of various search engines have incorporated features and techniques to make it easier for a user to tell which results may be useful. Techniques include:

adding a relevance metric for each result (such as percent relevance, or frequency of search term appearances in the referenced document);

ranking search results, for example, based on their relevance to the search term(s), frequency of search term appearances in the document, or the number of external links to the document;

categorizing search results so that, for example, users can choose entries for “python” that refer to snakes versus those that refer to a programming language; and

listing a portion of each relevant document along with each result so that users can read a bit of each entry to determine whether or not it appears to be useful.

### SUMMARY OF INVENTION

Although these techniques may make it easier for a user to choose useful results, the inventors have found that each technique has positive and negative attributes. For example, listing a portion of each corpus entry may allow users to see some of the content of the referenced document, giving them additional context for determining whether a result might be relevant. However, including additional content for each search result listing makes the list of results longer. Users may have more to read when looking at a list of search results, and they may therefore miss some relevant results. At least one study has shown that a large majority of users rarely read past the first three pages of search results and nearly one-quarter of users rarely read past the first few results. If a list of search results is lengthened by the inclusion of additional content, users may peruse fewer results overall and may miss some useful results that are farther down in the list.

Aspects of the invention provide a system and method for presenting computerized search results. In one embodiment, additional content may be displayed for each search listing without adding length to the search results list, and users may have the option to choose whether or not they wish to view the additional content for a particular listing. Embodiments of the invention may display the additional content in graphical form, such as in figures, photographs and/or algorithms.

In one aspect of the invention, a medical information system may return a list of one or more relevant results (e.g., titles of documents containing information relevant to a medical topic) for a search request, with each result linked to an outline of the content associated with that result. In one embodiment, the outline may be displayed in a sidebar when a user moves a mouse pointer over the result, without requiring a mouse click. The search engine used by the medical information system may perform any suitable operation to identify one or more results to a search inquiry, such as by keyword matching, word proximity, content analysis, search term frequency, author name matching, etc. The outline may include any suitable information, including section headings for the related content, hyperlinks, reader review information, chapter titles, one or more abstracts or other content summaries, one or more topics, author names, related medical conditions/symptoms, etc.

In one aspect of the invention, the display of an outline may be optional, such as based on a user's choice of whether or not to move a mouse pointer over a result displayed in a search results list.

In another aspect of the invention, an outline associated with a result displayed in a list may incorporate at least one hyperlink to the associated content, or even content of another related document. The at least one hyperlink may enable a user to navigate directly to a section within the associated content.

In another aspect of the invention, a medical information system may return a list of at least one relevant result, with at least one result linked to a graphic associated with that result. A thumbnail of the associated graphic may be displayed in a sidebar when a user moves a mouse pointer over the result, without requiring a mouse click. The associated full detail graphic may be displayed when the user clicks the mouse on the thumbnail graphic. The full detail graphic may contain a hyperlink to enable the user to navigate directly from the graphic to additional content with which the graphic is associated.

In another aspect of the invention, a system for providing computer search results includes a medical information resource having a plurality of stored information sets, where each of the information sets includes information relevant to at least one topic related to providing health care. For example, each information set may be content (e.g., a document, a topic, a graphic, a paragraph, etc.) that includes written text, charts, images or other graphic information, reference to published articles and other documents, etc. A search request module may receive a search request from a user to identify one or more information sets in the medical information resource. The search request may include at least one search criterion that represents one or more forms of content to be included in an information set to be identified in a search result, such as a keyword or other term or representation used to identify relevant documents. A search engine module may perform an analysis of information sets in the medical information resource to identify one or more information sets that satisfy the search request, thus identifying the one or more information sets as being part of a search result. A graphical user interface module may provide a first graphical user interface that includes a list of first indications for each of the one or more information sets identified in the search result. The first indication may be any suitable representation of an information set, such as a title for a document. The graphical user interface module may display additional information for an information set presented in the first graphical user interface based on the user's selection of the first indication for the information set in the list. The additional information may be incorporated into and displayed simultaneously with at least a portion of the first graphical user interface, yet be displayed separately from the list of first indications. For example, if a user positions a mouse cursor over a document title in the list in the first graphical user interface, an outline for the document may be presented in a separate pane in the user interface, or the outline may be presented in a non-obscuring position in the same pane of the first graphical user interface. The outline may allow the user to evaluate the document and determine if it is suitable for further review. By displaying the additional information separately from the list of first indications for information sets, the list may be kept relatively short, thereby helping the user to review the search results more effectively.

In another aspect of the invention, a method for presenting search results in a computerized medical information resource includes receiving a search request from a user to identify one or more information sets in a medical information resource. The search request may include at least one search criterion that represents content to be included in an information set to be identified in a search result. An analysis of information sets in the medical information resource may be performed to identify a search result that includes one or more information sets that satisfy the search request. A first indication for each of the one or more information sets identified in the search result may be presented to the user in a list in a first graphical user interface. Additional information for an information set presented in the list of the first graphical user interface may be presented based on the user's selection of the first indication for the information set. The additional information may be displayed separately from and simultaneously with at least a portion of the list in the first graphical user interface, e.g., allowing the user to evaluate a document without having to navigate through multiple display screens.

These and other aspects of the invention will be obvious and/or apparent from the following description. Various aspects of the invention may be used alone or in any suitable combination.

### BRIEF DESCRIPTION OF THE DRAWINGS

Aspects of the invention are described below with reference to illustrative embodiments shown in the figures in which like numerals reference like elements, and in which:

FIG. 1 shows a schematic view of a system for providing medical information in accordance with aspects of the invention;

FIG. 2 shows an illustrative graphical user interface displaying a search result;

FIG. 3 shows an illustrative graphical user interface displaying an outline and a related topic document;

FIG. 4 shows an illustrative graphical user interface displaying additional information or a selected topic title in a search result list;

FIG. 5 shows an illustrative graphic in the form of a chart;

FIG. 6 shows an illustrative graphic in the form of a decision algorithm;

FIG. 7 shows an illustrative graphic in the form of table listing; and

FIG. 8 shows an illustrative graphic in the form of image.

### DETAILED DESCRIPTION

Various aspects of the invention are described below with reference to specific embodiments. For example, aspects of the invention are described in the context of performing a search and review of results using a medical information resource. However, it should be understood that aspects of the invention are not necessarily restricted to this particular environment. Rather, various aspects of the invention may be used in any suitable system. For example, in describing a system for presenting computerized search results, we use as an example the search function in the UpToDate system. However, the features described may be used in a variety of search applications. In addition, various aspects of the invention may be used alone, and/or in combination with any other aspects of the invention.

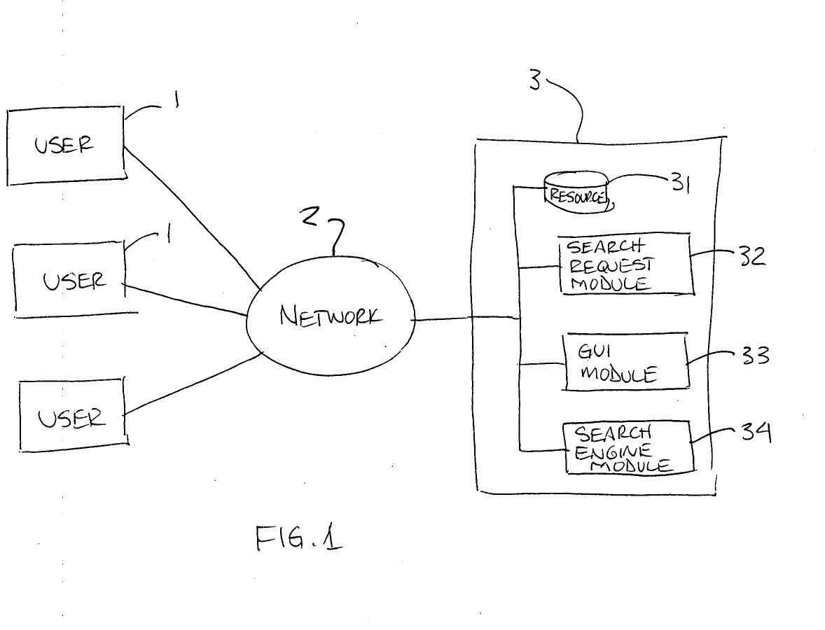

FIG. 1 shows a schematic diagram of a system for providing medical information in accordance with aspects of the invention. Users 1 interact with one or more computers that are linked to a network 2, such as the Internet, a telephone network, a local area network (LAN—whether wired or wireless), any other suitable communication network and/or any combination of such networks and devices. (As used herein, a computer includes, but is not limited to, programmable general purpose computing devices, including laptops, PDAs, electronic writing tablets, network servers, network terminals, and any other suitable device.) A medical information resource system 3 may have one or more computers that also communicate with the network 2 such that users 1 and the medical information resource system 3 may exchange information via the network 2. Users 1 may be individuals, such as doctors and/or other health care providers or other self-directed computer systems, that access the medical information resource system 3 for articles, analysis and/or other information used to assess, treat or otherwise provide care for a patient's medical condition. For example, users 1 may access an Internet website or other arrangement maintained by the medical information resource system 3 to obtain medical information. The website may include a search engine or other interface to allow a user to navigate and locate desired information, such as articles or other content offered by the medical information system 3. It should be understood that the arrangement in FIG. 1 is only illustrative, and that aspects of the invention may be implemented in other environments. For example, aspects of the invention may operate in an environment in which the medical information resource system 3 is located within the user 1 computer, and/or at a local network for the user computer.

One type of medical information provider is UpToDate of Waltham, Mass. (www.uptodate.com), which is referred to in the illustrative embodiments below. UpToDate provides an evidence-based clinical information resource available to physicians and designed to provide concise, practical answers to physicians at the point of care. Content within UpToDate's corpus is organized into topics within specialty areas and may include text, tables, graphics, animations, and other formats. Within topic documents, text and other content may be organized into sections and/or paragraphs, such as by diagnosis, treatment, differential diagnosis, pathophysiology, etiology, or other relevant headings. Keywords may be associated with portions of the text. As used herein, topic documents like those in the UpToDate system are “information sets.”

In this illustrative embodiment, the medical information system 3 includes a medical information resource 31, which may include one or more storage devices (volatile and/or non-volatile memory, such as semiconductor memory, magnetic tape or disc drives, optical storage, etc.) on which one or more medical information sets are stored. Each of the information sets typically include content relevant to at least one topic related to providing health care, and may include one or more sections of written text, graphics (such as graphs, cartoons, photographs, x-ray or other images, flow charts, decision trees, etc.), video images (such as a video clip presenting a surgical technique, medical condition or other), charts, tables, and/or other information. If the resource 31 includes two or more storage devices, the storage devices need not be located in a common place, but instead may be located in disparate locations such as in several different computers across a local or wide area network. Additionally, modules 32, 33, 34 need not be located in a common place, but instead may be located in disparate locations such as several different computers across a local or wide area network.

The medical information system 3 may also include a search request module 32 adapted to receive a search request from a user (or other computer) to identify one or more information sets in the medical information resource 31. The search request module 32 may receive the search request in any suitable format. For example, the search request may include at least one search criterion that represents content to be included in an information set to be identified in a search result. The criteria may be one or more keywords, an image or portion of an image, a natural language search string, or any other suitable indication of content to be used in identifying information sets in the resource 31 that are related to the search criteria. The user may provide the search criteria in any suitable way, such as by entering the criteria into a webpage dialog box viewed using a suitable browser application at the user location. Alternately, the search criteria may be provided in other ways. For example, the user may have a set of search criteria stored by the search request module 32, which implements the search criteria on a periodic basis, e.g., monthly so that the user may get regular updates regarding changes in a particular medical area. In another embodiment, the user 1 may provide a general indication of the information desired, and the search request module 32 may provide the search criteria used for a search. The search request module 32 may provide the criteria in an automated way, and/or a human operator at the medical information system 3 may provide the search criteria manually based on a review of the user request.

Based on the search request, a search engine module 34 may perform an analysis of information sets in the medical information resource 31 to identify one or more information sets that satisfy the search request, thereby identifying the one or more information sets as part of a search result. As used herein, to “satisfy” a search request means that the search request and/or any other suitable search terms, algorithm, etc., are used to identify an information set or sections of content within an information set that is suitably similar to, includes, or otherwise is related to the search request criterion. The search engine module 34 may operate in any suitable way to identify information sets as part of a search result, such as by keyword identification, keyword proximity detection, content evaluation, reference to an information set by other articles or documents, and so on. Such search techniques are well known in the art and therefore are not described in detail herein.

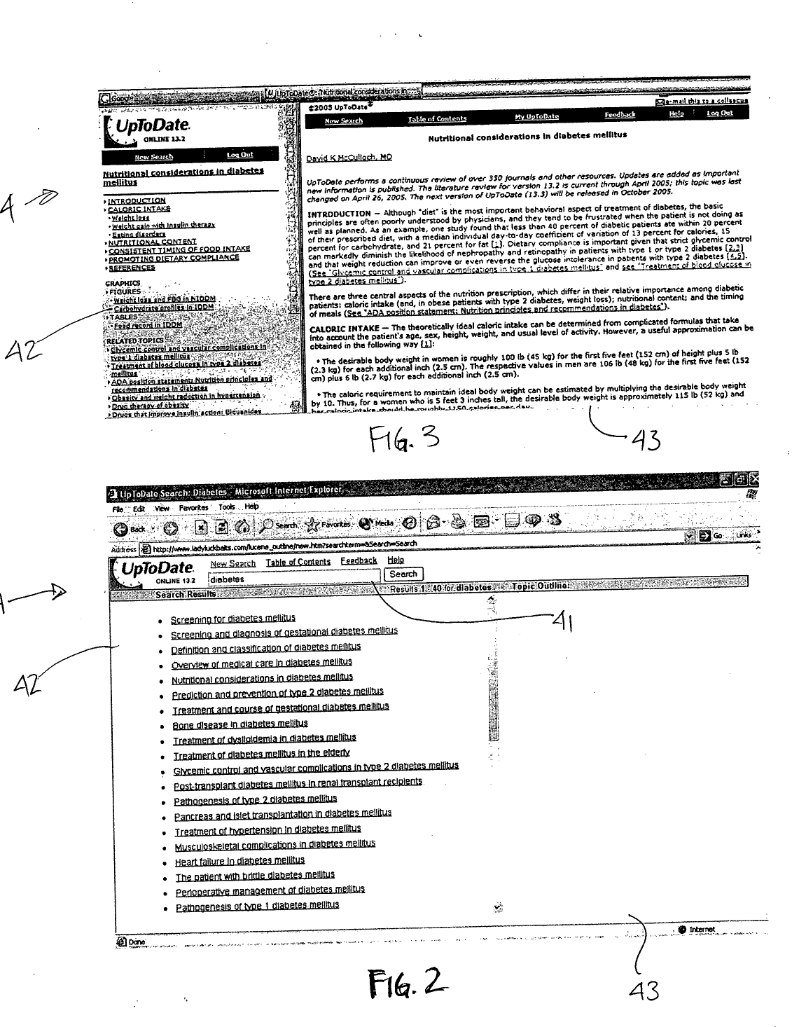

Search results identified by the search engine module 34 may be presented to the user 1 by a graphical user interface module 33. That is, the graphical user interface module 33 may be adapted to provide a graphical user interface for the user that includes an indication for the information sets in the search result. The indication may be arranged in any suitable way to indicate an information set to a user. For example, FIG. 2 shows an illustrative graphical user interface 4 in one embodiment of the invention. In this example, the user provided the search criterion “diabetes” in a search request dialog box 41. After performance of a search of information sets in the medical information resource 3 in response to the user clicking on the “search” button of the search request dialog box 41, the graphical user interface module 33 generated the graphical user interface 4 shown, which includes a listing of topic titles (e.g., a first indication for a related document in the resource 3) in a left pane 42. Indication of search results is not necessarily limited to a title listing. As used herein, a “list” of search results includes a columnar and/or table-like listing of document titles, as well as other concise indication(s) of search results, such as display of an indicator other than (or in addition to) a document title, e.g., a document reference number, author name, associated keywords, an associated graphic, a selected text portion, etc. In this embodiment, the left pane 42 includes a scroll bar so that a user 1 may adjust the left pane 42 so as to view topic titles lower down in the listing. However, it will be understood that the indication of documents provided in the graphical user interface may be arranged in other ways. At this point, the right pane 43 of the graphical user interface 4 is empty, but in other embodiments may include any desired information, such as advertisements, etc.

Each title indication shown in FIG. 2 may be hyperlinked to a document (i.e., a type of information set) in the medical information resource 3. Thus, a user 1 may click on an indication and thereafter have the corresponding document displayed on the graphical user interface 4. For example, if a user 1 wants to find information about nutritional considerations in diabetes patients, she might scroll through the list of indications in the left pane 42 of FIG. 2 and follow the hyperlink for the indication “Nutritional considerations in diabetes mellitus.” This may produce a result similar to that shown in FIG. 3, in which the topic title and an outline of the document are displayed in the left pane 42 along with the written text, graphics and other information in the corresponding document in the right pane 43. The outline may include a list of key headings, subheadings, content sections, and/or graphics of interest within a document, and each item in the list may be hyperlinked, allowing users to go directly to a portion of the document that may be of interest. In this graphical user interface 4, the user 1 may select a section in the outline displayed in the left pane 42, thereby causing the corresponding section to be displayed in the right pane 43. This control of the graphical user interface, along with retrieval of information from the resource 3, etc., is performed by the graphical user interface module 33. Once the user 1 has reviewed one or more sections of the document, she might use her browser's “Back” button or other suitable control to go back to the search results list of FIG. 2, where she might follow another document link.

However, as noted earlier, it is not always easy to determine from the search listing which document will be the most useful to find relevant information. Sometimes, finding the information requires following more than one hyperlink and looking at more than one document. Because following multiple hyperlinks and scanning through multiple documents may be time-consuming, and because medical professionals may not have time available to do so, users may sometimes give up on a search, choosing to seek answers elsewhere, to answer the question at a later time, or even to put aside the question entirely.

User studies performed by UpToDate have suggested that frequently when a user I fails to find the information she was seeking, the information was actually available. Often, the user 1 may have made her best guess as to which search result might contain the information, based on the brief title listing, but may have chosen the wrong document link to follow and read. In many cases, and in the example of UpToDate's medical database in particular, it is desirable for users to find relevant information reliably and quickly.

In accordance with an aspect of the invention, the graphical user interface module 33 may be adapted to display additional information for an information set presented in the graphical user interface based on the user's selection of an indication for the information set. The additional information may be incorporated into and displayed simultaneously with at least a portion of the list of information set indications in the graphical user interface, thus obviating any need to navigate through multiple interface screens. For example, if a user 1 viewing the graphical user interface 4 of FIG. 2 positions the mouse cursor over a particular indication in the left pane 42, additional information related to the selected indication may be displayed in the right pane 43. FIG. 4 shows a graphical user interface 4 that may result when the user 1 positions the mouse cursor or otherwise selects the indication “Nutritional considerations in diabetes mellitus.” In this example, the additional information displayed in the right pane 43 includes the topic title (in the upper portion of the right pane 43) along with an outline of the associated document. (The user 1 need not actually “click” on the topic indication to cause the display of additional information, but rather may only position the mouse cursor near the topic indication.) Similar to the arrangement discussed above with respect to FIG. 3, the user 1 may select a section of the outline by clicking on that section of the outline and cause the display of the corresponding text, etc. of the topic document. Display of the document section may be made in a third pane of the graphical user interface 4 and/or in a separate window.

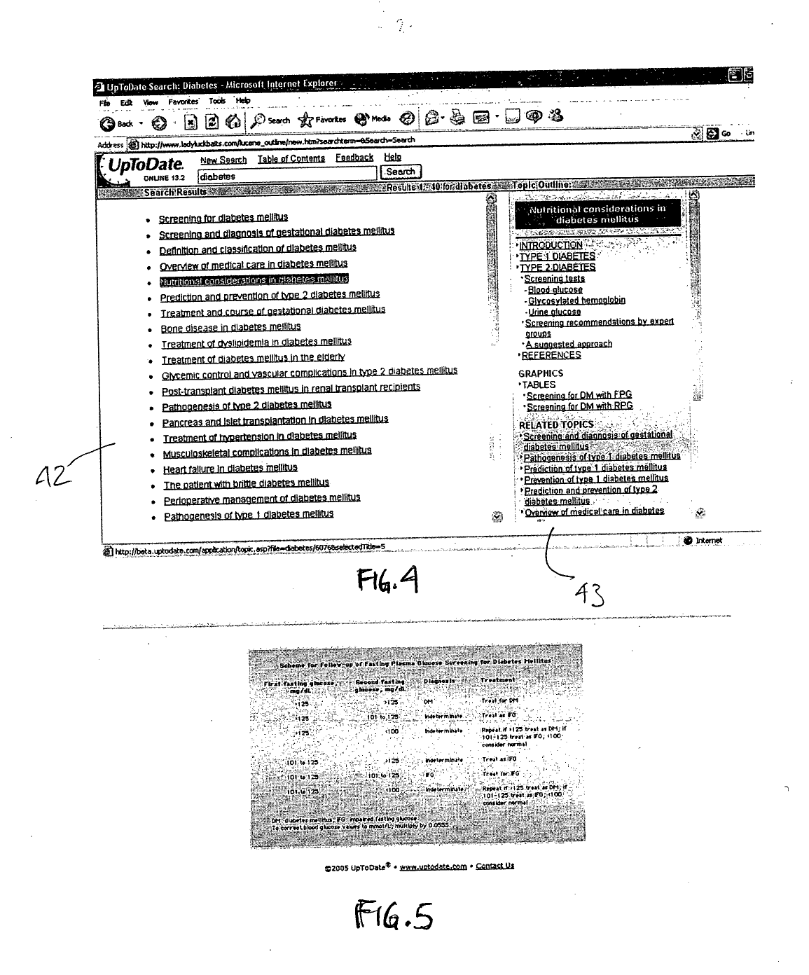

The additional information provided for a selected document indication may also include secondary indications for one or more graphics, such as tables, graphs, etc. In FIG. 4, two tables are listed in the right pane 43 for the selected document indication, i.e., “Screening for DM with FPG” and “Screening for DM with RPG.” Selection of one of these secondary indications, e.g., “Screening for DM with FPG”, may result in the display of the corresponding table or other graphic, such as that shown in FIG. 5. The display of the graphic may be made in a separate window, in an additional pane of the graphical user interface 4, by replacing the left and right panes 42 and 43 with a single pane display, etc.

Other secondary indications that may be provided with the additional information for a selected document are those for related topic documents, as shown at the lower end of the right pane 43 in FIG. 4. These related topics may be “hand selected,” e.g., by human-directed grouping of topics into related groups, or the related topics displayed may be automatically identified, e.g., by using suitable software to compare the content of documents and identifying those documents that are suitably related to each other. Since the outline may reference related documents, and since those documents may be similar to those found in the search results, the user may follow a hyperlink from the outline to another document, rather than using her browser's “Back” button every time she wants to look at another listing from the search results, thus simplifying navigation. Relationships between documents may be stored, for example, in the medical information resource 3 or in any other suitable way. For example, each document may have a related file that indicates one or more document groups to which the document is associated. These group associations may be used to generate the “related topic” display like that provided in FIG. 4, e.g., if a document is related to “Group 4” all of the other documents that are related to “Group 4” may be displayed with the additional information.

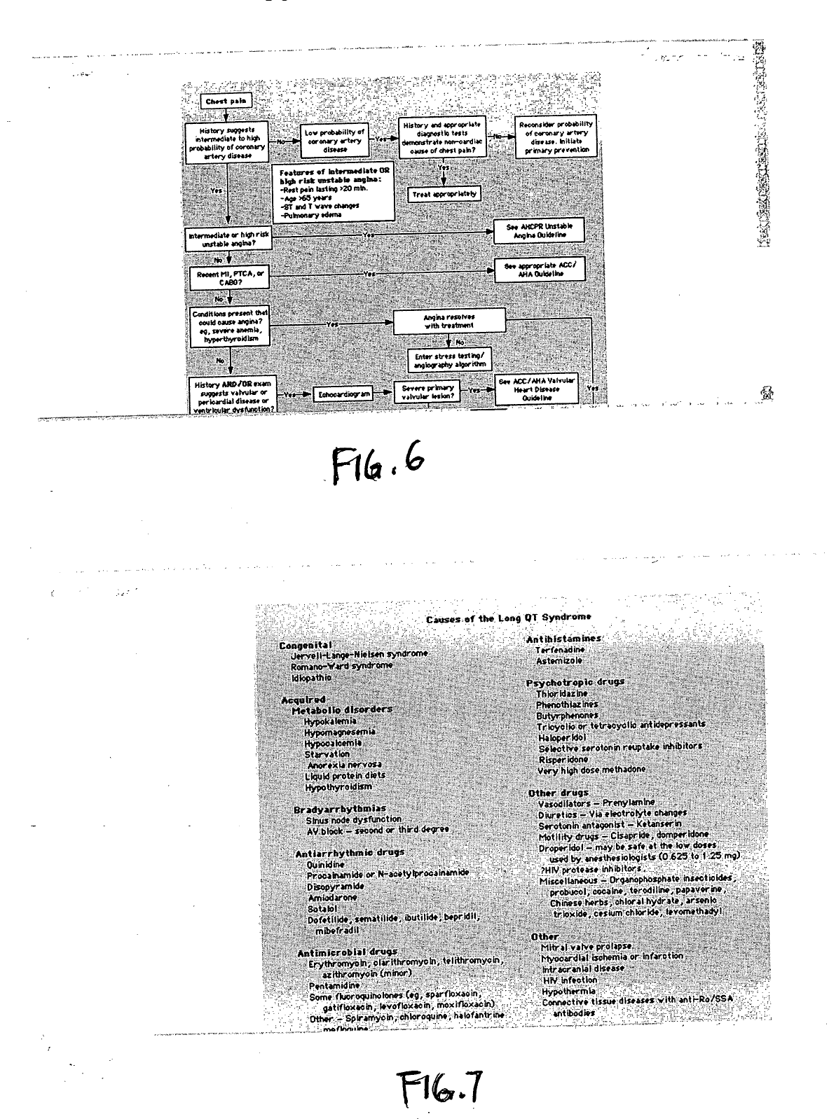

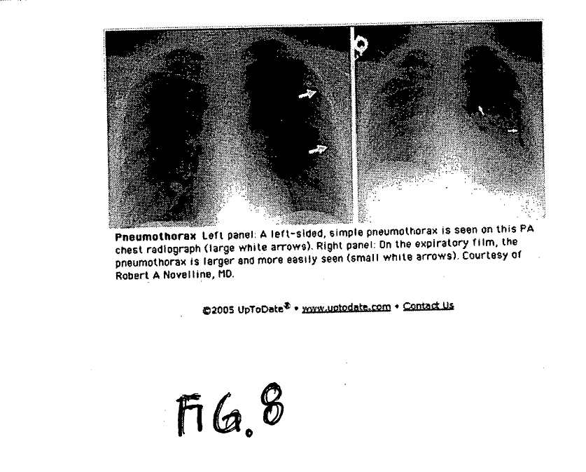

As alluded to above, in some cases, the most relevant information for a user may be found in graphical form, such as in a figure or a graphical algorithm, rather than in the text portions of a document. Examples of such graphical information are shown in FIG. 6 (partial algorithm, “Algorithm assessment for chest pain”), FIG. 7 (partial table, “Causes of long QT syndrome”), and FIG. 8 (radiograph, “Pneumothorax PA”). In these cases, the additional information displayed along with a list of document indications from a search result may accommodate alternate indications for graphical content. For example, if the search engine module 34 is able to locate graphics such as figures and algorithms within documents, the graphical user interface module 33 may indicate those graphics in the search results list, e.g., along with document indications in the left pane 42. In such cases, when the user 1 moves her mouse pointer over an indication for a graphic, instead of displaying a document outline as in the example of FIG. 4, a thumbnail of the relevant graphic may be displayed, e.g., in the right pane 43 of FIG. 4. Clicking on the thumbnail may bring the user directly to the graphic within the document. In addition, link(s) may be made available with the graphic to enable the user to navigate directly from the graphic to the document(s) with which it is associated.

Each of the modules 31, 32, 33 and 34 of the medical information system 3 may include suitable computer data storage devices, computer useable data (such as text, graphics or other information in any suitable database, file or other format), communication devices to enable communication within the module and with other modules over a communications link using any suitable communications protocol, data processing devices (such as one or more computer processors), software or other suitable instructions for carrying out the various functions of the module, user input/output devices (such as user pointing devices, a touch screen, printer, computer display, and so on) and/or any other components or devices. The modules 31, 32, 33 and 34 may be located in a single computer, or may be distributed (either in whole or in part) across multiple devices. Thus, the system 3 need not be located in a single location, but instead may be formed by a plurality of different, physically separate components.

While aspects of the invention have been described in conjunction with specific embodiments thereof, it is evident that many alternatives, modifications, and variations will be apparent to those skilled in the art. Accordingly, embodiments of the invention as set forth herein are intended to be illustrative, not limiting. Various changes may be made without departing from the spirit and scope of the invention.

1. A system for providing computer search results, comprising:
a medical information resource including a plurality of stored information sets, each of the information sets including information relevant to at least one topic related to providing health care;
a search request module adapted to receive a search request from a user to identify one or more information sets in the medical information resource, the search request including at least one search criterion that represents content included in an information set to be identified in a search result;
a search engine module adapted to perform an analysis of information sets in the medical information resource to identify one or more information sets that satisfy the search request, the identified one or more information sets being part of a search result; and
a graphical user interface module adapted to provide a first graphical user interface including a first indication for the one or more information sets identified in the search result, the first indication for the information sets in the search result being displayed in a list,
wherein the graphical user interface module is adapted to display additional information for an information set presented in the first graphical user interface based on the user's selection of the first indication for the information set, the additional information being displayed separate from and simultaneously with at least a portion of the list of information sets in the first graphical user interface.

2. The system of claim 1, wherein the first indication includes a hyperlink to the corresponding information set.

3. The system of claim 1, wherein the additional information includes an outline of content in the information set, a listing of graphics in the information set, or a listing of related information sets.

4. The system of claim 1, wherein the first indication includes a topic title for the corresponding information set, the corresponding information set includes a topic document having multiple sections with at least one section including written text, and the additional information includes an outline for the topic document, with the outline including headings for each section of the topic document.

5. The method of claim 4, wherein the additional information includes hyperlinks to each section of the topic document.

6. The method of claim 4, wherein the topic title includes a description of the corresponding information set that includes no more than 15 words.

7. The method of claim 4, wherein the additional information includes an indication of a graphic included in the topic document.

8. The method of claim 7, wherein the indication of a graphic includes a thumbnail of the graphic.

9. The system of claim 1, wherein the user selects the first indication by positioning a mouse pointer near the first indication in the graphical user interface without clicking on the first indication.

10. The system of claim 1, wherein the first indication selected by the user is a topic title and the additional information includes a list of related topic documents to the selected topic title.

11. A method for presenting search results in a computerized medical information resource, comprising:
receiving a search request from a user to identify one or more information sets in a medical information resource, the search request including at least one search criterion that represents content included in an information set to be identified in a search result;
performing an analysis of information sets in the medical information resource to identify a search result that includes one or more information sets that satisfy the search request;
presenting a first indication for each of the one or more information sets identified in the search result to the user, the first indication for information sets in the search result being presented to the user in a list in a first graphical user interface; and
displaying additional information for an information set presented in the list of the first graphical user interface based on the user's selection of the first indication for the information set, the additional information being displayed separate from and simultaneously with at least a portion of the list in the first graphical user interface.

12. The method of claim 11, wherein the first indication includes a hyperlink to the corresponding information set.

13. The method of claim 11, wherein the additional information includes an outline of content in the information set, a listing of graphics in the information set, and/or a listing of related information sets.

14. The method of claim 11, wherein the first indication includes a topic title for the corresponding information set, the corresponding information set includes a topic document having multiple sections with at least one section including written text, and the additional information includes an outline for the topic document, with the outline including headings for each section of the topic document.

15. The method of claim 14, wherein the additional information includes hyperlinks to each section of the topic document.

16. The method of claim 14, wherein the topic title includes a description of the corresponding information set that includes no more than 15 words.

17. The method of claim 14, wherein the additional information includes an indication of a graphic included in the topic document.

18. The method of claim 17, wherein the indication of a graphic includes a thumbnail of the graphic.

19. The method of claim 11, wherein the user selects the first indication by positioning a mouse pointer near the first indication in the graphical user interface without clicking on the first indication.

20. A system for providing computer search results, comprising:
a medical information resource including a plurality of stored medical topic documents, each of the medical topic documents including information relevant to at least one topic related to providing health care;
a search request module adapted to receive a search request from a user to identify one or more medical topic documents in the medical information resource, the search request including at least one keyword that represents content included in a medical topic document to be identified in a search result;
a search engine module adapted to perform an analysis of the stored medical topic documents in the medical information resource to identify one or more medical topic documents that satisfy the search request, the identified one or more medical topic documents being part of a search result; and
a graphical user interface module adapted to provide a first graphical user interface including a topic title for one or more medical topic documents identified in the search result,
wherein the graphical user interface module is adapted to display additional information for a medical topic document presented in the first graphical user interface based on the user's selection of the topic title for the medical topic document, the additional information being incorporated into and displayed simultaneously with at least a portion of the first graphical user interface.

21. The system of claim 20, wherein the additional information includes an outline for the topic document corresponding to the selected topic title.

22. The system of claim 21, wherein the additional information includes topic titles for related topic documents corresponding to the selected topic title.
